(19) United States
(12) Patent Application Publication
(10) Pub. No.: US 2011/0156413 A1
(43) Pub. Date: Jun. 30, 2011

(54) Latch for by-pass sliding doors

(76) Inventor: John Teuthorn, Glendale Heights, IL (US)

(21) Appl. No.: 12/971,217

(22) Filed: Dec. 17, 2010

Related U.S. Application Data
(60) Provisional application No. 61/290,325, filed on Dec. 28, 2009.

(51) Int. Cl. E05B 15/02

(52) U.S. Cl. 292/341.15

(57) ABSTRACT

A lock or closure device for by-pass sliding doors which can be installed on the edge of one or more such sliding doors for blocking and restricting entry through the doors, wherein the device is mounted on the edge of one of the doors and has a latch which is engageable against the edge of the other door, wherein the latch includes structure for selectively moving the latch into and out of blocking arrangement of the other door from a point exterior to the overlapping doors.

### PRIORITY CLAIM

Applicant claims priority from his provisional application Ser. No. 61/290325 for a LATCH FOR BY-PASS SLIDING COORS, filed in the United States Patent and Trademark Office on Dec. 28, 2009.

### BACKGROUND AND SUMMARY OF THE INVENTION

This invention relates to a lock or closure for by-pass sliding doors, and is more particularly concerned with a novel latch which can be installed on the edge of one or more of such sliding doors for the purpose of restricting entry through the doors, and is useful in providing a safe environment for children.

A spring loaded “L” shaped member or bar movably secured in a bracket is attached to the edge of the one or more sliding door, preferably with permanent two sided tape, in a position where that edge overlaps the adjacent sliding door. This bracket has a latch receiver or bracket which includes a spacer to maintains the doors spaced apart during sliding and orients the “L” shaped member relative to the door. The “L” shaped member has one leg slidably rotationally captured in the bracket and has a handle which when grasped and manipulated in a 90 degree arc caused another leg of the “L” shaped member to lodge against the edge of the other or adjacent sliding door to latch that door in place, but when the handle is manipulated in an opposed direction away from the edge of the other door, the doors are free of the latch so that the doors are permitted to slide in a normal by-pass manner relative to one another. By use of a device embodying the present invention, by-pass sliding doors may not be easily opened by children or unauthorized persons to expose items which are intended to be unavailable.

A search of the prior art revealed several latching devices for by-pass closures, such as:

Calteux U.S. Pat. No. 5,918,915, issued Jul. 6, 1999 fora SLIDING DOOR LOCK;

Dinan U.S. Pat. No. 5,125,699, issued Jun. 30, 1992, for a WINDOW LOCKING ACCESSORY;

Hightower U.S. Pat. No. 6,533,374, issued Mar. 18, 2003, for CLIPS FOR RESTRAINING FURNITURE DOORS FROM VERTICAL AND HORIZONTAL MOVEMENT DURING SHIPPING AND HANDLING;

but these devices must be removed from the doors in order to release the latched door from the door on which the device was mounted.

Other devices in the prior art, such as the following:

Cardoso U.S. Pat. No. 4,061,372. Issued Dec. 6, 1977, for a SECONDARY LOCK FOR SLIDING DOOR OR WINDOW;

Gibbons, US Patent Application publication No. US 2009/0212578, published Aug. 27, 2009, for a LATCH FOR SLIDING DOOR OR FRAME;

McQuiston U.S. Pat. No. 3,267,613, issued Aug. 23, 1966, for a LOCK FOR SLIDABLY MOUNTED CLOSURES;

Cater, Sr. U.S. Pat. No. 4,932,694, issued Jun. 12, 1990, for a WINDOW AND DOOR LOCK;

Jourdenais U.S. Pat. No. 6,000,735, issued Dec. 14, 1999, for an AUTOMATIC CHILD-RESISTANT SLIDING DOOR LOCK;

Dominguez U.S. Pat. No. 4,552,395, issued Nov. 12, 1985, for a COLLAPSIBLE WEDGE FOR SLIDING DOORS AND WINDOWS;

Stevens U.S. Pat. No. 4,248,461, issued Feb. 3, 1981, for a SLIDING DOOR LOCKING APPARATUS;

Jones PCT./AU99/00371, filed May 20, 1998 (priority date), for a PARTIALLY CONCEALED SECONDARY LOCKING DEVICE FOR USE IN SLIDING DOORS AND/OR WINDOWS,

Gross U.S. Pat. No. 6,070,922, issued Jun. 6, 2000, for a SHOWER DOORS LOCKING DEVICE;

Asp U.S. Pat. No. 4,407,539, issued Oct. 4, 1983, for a LATCH FOR SLIDING GLASS DOOR;

are generally pertinent, but all of these devices required modification of the doors on which they were to be mounted, or had unsightly appearance from the face of the doors or were not accessible for use from one side of the door.

### OBJECTS AND ADVANTAGES OF THE INVENTION

It is the object of the invention to provide a latch for by-pass sliding doors of the character described.

Another object is to provide such a device which is easy to install and effective to use.

Another object is to provide such a latch which is easy to install and is effective to use.

Another object is to provide a safe environment for children.

Another object is to provide a latch which is simple to manufacture.

These and other objects and advantages of the invention will become more apparent as this description proceeds, taken in conjunction with the accompanying drawings.

### BRIEF DESCRIPTION OF THE DRAWINGS

In the drawings:

FIG. 1 is a perspective view of a latch embodying the invention mounted on the edge of a door in position blocking the other by-pass door.

FIG. 2 is an elevational view of the latch on a door similar to FIG. 1, showing the pivotable handle in dotted lines.

FIG. 3 is a view of the latch on a door, partially in section, showing the by-pass doors in latched position.

FIG. 4 is a view of the latch on a door similar to FIG. 3, except showing the latching device in open or unlatched position.

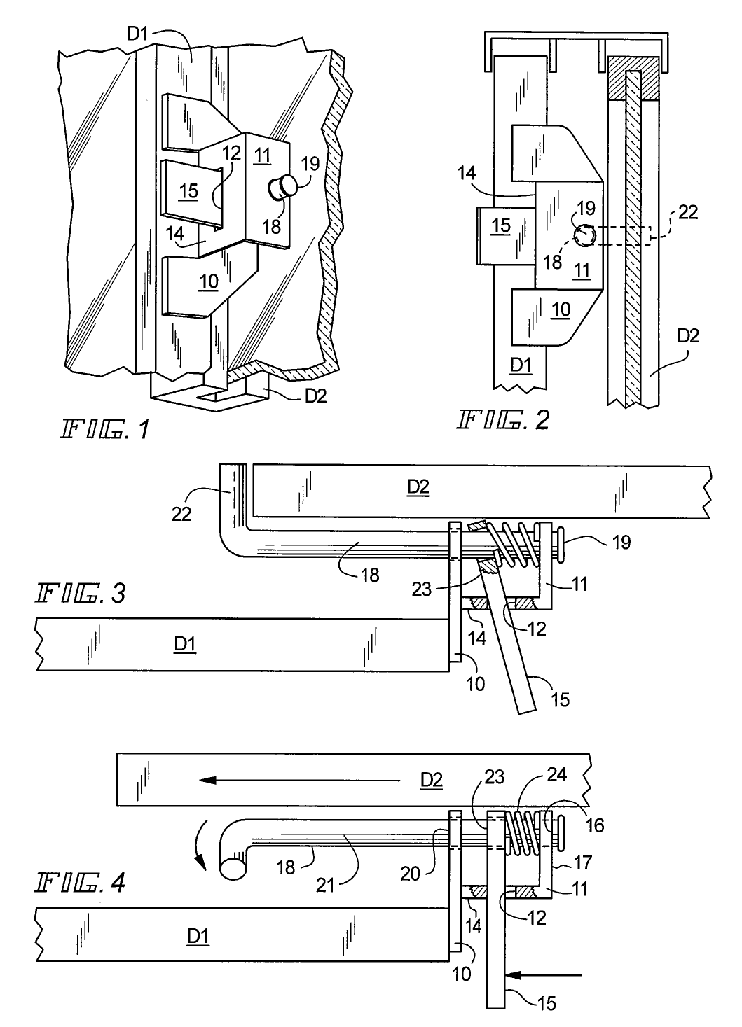

### DESCRIPTION OF A PREFERRED EMBODIMENT

With reference to the accompanying drawing, showing a door D1 on which the novel latch is mounted and an adjacent Door D2 which is closed or latched by the novel latching mechanism embodying the present invention. This novel latching mechanism comprises a plate 10 which is secured to the Door D1 by any convenient means, such as a double sided tape or a velcro pad or a screw or similar fastening member, An L shaped bracket 11 is secured to the plate 10, and this bracket has an first aperture 12 on a first leg 14 of the bracket 11 for receiving a handle 15. A second aperture 16 through second leg 17 of the bracket 11 receives a pivotable shaft or bar 18 which is rotatably secured in the bracket 11 by an enlargement 19 at one end of the bar extending through the second bracket aperture 16 and another aligned aperture 20 in the plate 10.

The pivotable bar or shaft 18 is L shaped, and has a long leg 21 which extends through the shaft and bracket, as previously described, and a short leg 22, which is about as long as the width of the edge of the door D2. The handle 15 is spring loaded, and its one end 23 is rockably pivotably securely connected to the bar 18. The spring 24 is arranged on the bar 18 between the handle 15 and the second leg 17 of the bracket 11.

In operation, the doors D1 and D2 are latched together and one door cannot move past the other door when the doors are in the latched position shown in FIG. 3, with the short leg 22 of the bar 18 blocking movement of the door D2. When it is desired to free door D2 for by-pass sliding movement, the handle 15 is grasped and rockingly moved toward the door D1 on which the latching device is mounted, thus compressing the spring 24, and the short leg 22 is pivoted at least 45 degrees to free the latched door D2 for sliding in the direction of the arrows as shown in FIG. 4. Re-latching is accomplished by closing the doors D1 and D2 and moving the handle at least 45 degrees thus pivoting the bar18 to latch the short leg 22 against the edge of the latched door D2.

While a preferred embodiment of the invention has been disclosed and discussed in considerable detail, many modifications and changes in the structure can be made without departing from the spirit and scope of the invention. Thus it is not intended that the invention should be limited, except for the claims presented herewith.

1. A device for latching by-pass sliding doors in a selected open or closed position, said device comprising:
a bracket attached to one edge of one of said doors in a position adapted for alignment adjacent the edge of a second of said doors,
an L shaped member movably and pivotably secured in said bracket;
said L shaped bracket having one leg slideably and rotatably secured in said bracket;
a second leg attached to and angularly extending from said first leg;
said second leg adapted to block said second door for movement
of said doors when arranged in one position against said second door and to free said second door for sliding movement past said first door when arranged in a second position; and
handle means on said L shaped bracket for moving said second leg from said first position to said second position and from said second position to said first position.

2. The device recited in claim 1, wherein said L shaped member has a spring member for spring loading said leg in said bracket.

3. The device recited in claim 2, wherein said spring member extends around said one leg.

4. The device recited in claim 2, wherein said spring member bears against said bracket and said handle means.

5. The device recited in claim 2, wherein said spring member restrains unintended movement of said handle means.

6. The device recited in claim 2, wherein said L shaped member has an enlargement on an end remote from said second leg to restrain said member in said bracket.

7. The device recited in claim 1 wherein said second leg is movable in a 90 degree arc.

8. The device recited in claim 1, wherein said bracket has a flat plate for mounting said device on the said edge of one of said doors.

9. The device recited in claim 8, wherein said plate is secured to said edge by a Velcro pad.

10. The device recited in claim 8, wherein said plate is secured to said edge by two sided tape.

11. The device recited in claim 1, wherein said bracket has an aperture for receiving said L shaped leg.

12. The device recited in claim 1, wherein said handle means has an aperture for slideably receiving said one leg therein.

13. The device recited in claim 12, wherein said bracket has an aperture for rockably receiving said handle means therein.

14. The device received in claim 1, wherein said device has spacing means for maintaining said doors in aligned relation.
